(19) United States
(12) Patent Application Publication
(10) Pub. No.: US 2020/0151849 A1
(43) Pub. Date: May 14, 2020

(54) VISUAL STYLE TRANSFER OF IMAGES

(71) Applicant: MICROSOFT TECHNOLOGY LICENSING, LLC, Redmond, WA (US)

(72) Inventors: Jing LIAO, Redmond, WA (US); Lu YUAN, Redmond, WA (US); Gang HUA, Redmond, WA (US); Sing Bing KANG, Redmond, WA (US)

(73) Assignee: MICROSOFT TECHNOLOGY LICENSING, LLC, Redmond, WA (US)

(21) Appl. No.: 16/606,629

(22) PCT Filed: Apr. 6, 2018
(86) PCT No.: PCT/US2018/026373

§ 371 Date: Oct. 18, 2019

(30) Foreign Application Priority Data
Apr. 20, 2017 (CN) 201710262471.3

(51) Int. Cl. G06T 3/00; G06T 11/60; G06T 5/50

(52) U.S. Cl. CPC G06T 3/0012; G06T 11/60; G06T 3/0068; G06T 2207/20221; G06T 5/50; G06T 2207/20084; G06T 2207/20081; G06T 3/0093

(57) ABSTRACT

According to implementations of the subject matter, a solution is provided for visual style transfer of images. In this solution, first and second sets of feature maps are extracted for first and second source images, respectively, a feature map in the first or second set of feature maps representing at least a part of a visual style of the first or second source image. A first mapping from the first source image to the second source image is determined based on the first and second sets of feature maps. The first source image is transferred based on the first mapping and the second source image to generate a first target image at least partially having the second visual style. Through this solution, a visual style of a source image can be effectively applied to a further source image in feature space.

### BACKGROUND

A visual style of an image can be represented by one or more dimensions of visual attributes presented by the image. Such visual attributes include, but are not limited to, color, texture, brightness, lines and the like in the image. For example, the real images collected by image capturing devices can be considered as having a visual style while the artistic works such as oil painting, sketch, and watercolor painting can also be considered as having other different visual styles. Visual style transfer of images refers to transferring the visual style of one image to the visual style of another image. The visual style of an image is transferred with the content presented in the image remained substantially the same. For instance, if the image originally includes contents of architecture, figures, sky, vegetation, and so on, these contents would be substantially preserved after the visual style transfer. However, one or more dimensions of visual attributes of the contents may be changed such that the overall visual style of that image is transferred for example from a style of photo to a style of oil painting. Currently it is still a challenge to obtain effective visual style transfer of images with high quality.

### SUMMARY

According to implementations of the subject matter described herein, there is provided a solution for visual style transfer of images. In this solution, a first set of feature maps for a first source image and a second set of feature maps for a second source image are extracted. A feature map in the first set of feature maps represents at least a part of a first visual style of the first source image in a respective dimension, and a feature map in the second set of feature maps represents at least a part of a second visual style of the second source image in a respective dimension. A first mapping from the first source image to the second source image is determined based on the first and second sets of feature maps. The first source image is transferred based on the first mapping and the second source image to generate a first target image at least partially having the second visual style. Through this solution, a visual style of one source image can be effectively applied to a further source image in feature space.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a block diagram of a computing device in which implementations of the subject matter described herein can be implemented;

FIG. 2 illustrates example images involved in the process of visual style transfer of images;

FIG. 3 illustrates a block diagram of a system for visual style transfer of images in accordance with an implementation of the subject matter described herein;

FIG. 4 illustrates a schematic diagram of example feature maps extracted by a learning network in accordance with an implementation of the subject matter described herein;

FIG. 5 illustrates a block mapping relationship between a source image and a target image in accordance with an implementation of the subject matter described herein;

FIGS. 6A and 6B illustrate structural block diagrams of the mapping determination part in the module of FIG. 3 in accordance with an implementation of the subject matter described herein;

FIG. 7 illustrates a schematic diagram of fusion of a feature map with and a transferred feature map in accordance with an implementation of the subject matter described herein; and

FIG. 8 illustrates a flowchart of a process for visual style transfer of images in accordance with an implementation of the subject matter described herein.

Throughout the drawings, the same or similar reference symbols refer to the same or similar elements.

### DETAILED DESCRIPTION

The subject matter described herein will now be discussed with reference to several example implementations. It would be appreciated these implementations are discussed only for the purpose of enabling those skilled persons in the art to better understand and thus implement the subject matter described herein, rather than suggesting any limitations on the scope of the subject matter.

As used herein, the term “includes” and its variants are to be read as open terms that mean “includes, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or same objects. Other definitions, explicit and implicit, may be included below.

### Example Environments

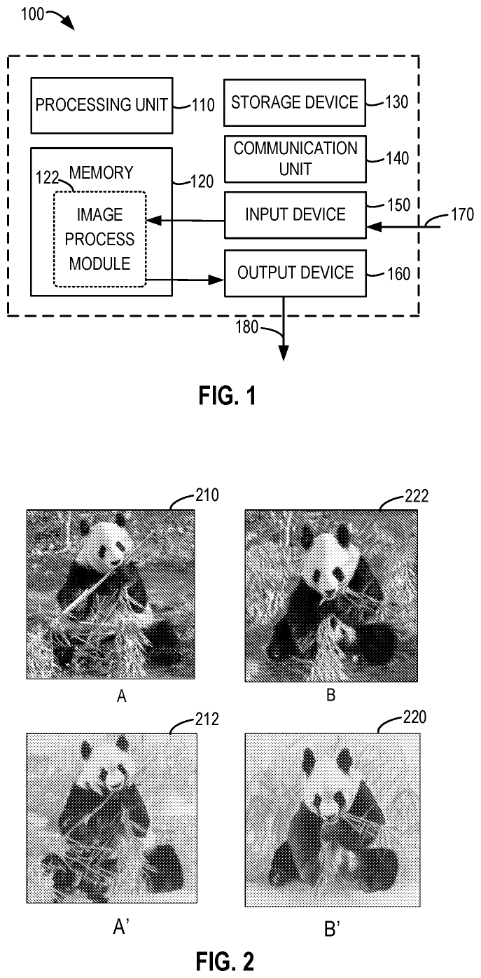

Basic principles and various example implementations of the subject matter will now be described with reference to the drawings. FIG. 1 illustrates a block diagram of a computing device 100 in which implementations of the subject matter described herein can be implemented. It would be appreciated that the computing device 100 shown in FIG. 1 is merely illustration but not limiting the function and scope of the implementations of the subject matter described herein in any way. As shown in FIG. 1, the computing device 100 includes a computing device 100 in form of a general-purpose computing device. The components of the computing device 100 include, but are not limited to, one or more processors or processing units 110, a memory 120, a storage device 130, one or more communication units 140, one or more input devices 150, and one or more output devices 160.

In some implementations, the computing device 100 can be implemented as various user terminals or service terminals with computing capability. The service terminals may be servers, large-scale computer devices, and other devices provided by various service providers. The user terminals, for example, are any type of mobile terminals, fixed terminals, or portable terminals, including mobile phones, stations, units, devices, multimedia computers, multimedia tablets, Internet nodes, communicators, desktop computers, laptop computers, notebook computers, netbook computers, tablet computers, Personal Communication System (PCS) devices, personal navigation devices, Personal Digital Assistants (PDAs), audio/video players, digital camera/camcorders, positioning devices, television receivers, radio broadcast receivers, electronic book devices, game devices, or any combination thereof, including the accessories and peripherals of these devices or any combination thereof. It is also contemplated that the computing device 100 can support any type of interface to the user (such as “wearable” circuitry and the like).

The processing unit 110 can be a physical or virtual processor and perform various processes based on the programs stored in the memory 120. In a multi-processor system, multiple processing units perform computer-executable instructions in parallel to improve the parallel processing capability of the computing device 100. The processing unit 110 can also be referred to as a Central Processing Unit (CPU), microprocessor, controller, or microcontroller.

The computing device 100 usually includes various computer storage media. Such media can be any available media accessible by the computing device 100, including but not limited to volatile and non-volatile media, and removable and non-removable media. The memory 120 can be a volatile memory (such as a register, cache, random access memory (RAM)), or a non-volatile memory (such as a Read-Only Memory (ROM), Electrically Erasable Programmable Read-Only Memory (EEPROM), flash memory), or any combination thereof. The memory 120 includes an image processing module 122 configured to perform the functions of various implementations described herein. The image processing module 122 can be accessed and executed by the processing unit 110 to implement the corresponding functions.

The storage device 130 can be removable or non-removable media and can include machine-readable media for storing information and/or data and being accessed in the computing device 100. The computing device 100 can also include further removable/non-removable and volatile/non-volatile storage media. Although not illustrated in FIG. 1, a disk drive can be provided for reading/writing to/from the removable and non-volatile disk and an optical drive can be provided for reading/writing to/from the removable and volatile optical disk. In this case, each drive can be connected to a bus (not shown) via one or more data medium interfaces.

The communication unit 140 communicates with a further computing device through communication medium. Additionally, the functions of the components of the computing device 100 can be implemented as a single computing cluster or multiple computing machines connected communicatively for communication. Thus, the computing device 100 can operate in a networked environment using a logic link with one or more other servers, personal computers (PCs), or other general network nodes.

The input device 150 can be one or more various input devices such as a mouse, keyboard, trackball, voice input device, and/or the like. The output device 160 can be one or more output devices such as a display, loudspeaker, printer, and/or the like. The computing device 100 can further communicate with one or more external devices (not shown) as required via the communication unit 140. The external devices, such as a storage device, a display device, and the like, communicate with one or more devices that enable users to interact with the computing device 100, or any devices that enable the computing device 100 to communicate with one or more other computing devices (for example, a network card, modem, and the like). Such communication can be achieved via an input/output (I/O) interface (not shown).

The computing device 100 can implement visual style transfer of images in various implementations of the subject matter described herein. As such, the computing device 100 sometimes is sometimes referred to as an “image processing device 100” hereinafter. In implementing the visual style transfer, the image processing device 100 can receive a source image 170 through the input device 150. The image processing device 100 can process the source image 170 to change an original visual style of the source image 170 to another visual style and output a stylized image 180 through the output device 160. The visual style of images herein can be represented by one or more dimensions of visual attributes presented by the image. Such visual attributes include, but are not limited, to color, texture, brightness, lines, and the like in the image. Thus, a visual style of an image may relate to one or more aspects of color matching, light and shade transitions, texture characteristics, line roughness, line curving, and the like in the image. In some implementations, different types of images can be considered as having different visual styles, examples of which include photos captured by an imaging device, various kinds of sketches, oil painting, and watercolor painting created by artists, and the like.

Visual style transfer of images refers to transferring a visual style of one image into a visual style of another image. There are some solutions that can transfer the visual styles of images. In some conventional solutions, in order to transfer a first visual style of an input image to a second style, a reference image with the first visual style and a reference image with the second visual style are needed. That is, the appearances of the reference images with different visual styles have been known. Then, a style mapping from the reference image with the first visual style to the reference image with the second visual style is determined and is used to transfer the input image having the first visual style so as to generate an output image having the second visual style.

For example, as shown in FIG. 2, the conventional solutions require a known reference image 212 (represented as A) having a first visual style and a known reference image 214 (represented as A′) having a second visual style to determine a style mapping from the first visual style to the second visual style. The reference images 212 and 214 present different visual styles but include substantially the same image contents. In the example of FIG. 2, the first visual style represents that the reference image 212 is a real image while the second visual style represents that the reference image 214 is a watercolor painting of the same image contents as the image 212. With the determined style mapping, a source image 222 (represented as B) having the first visual style (the style of real image) can be transferred to a target image 224 (represented as B′) having the second visual style (the style of watercolor painting). In this solution, the process of obtaining the image 224 is to ensure that the relevance from the reference image 212 to the reference image 214 is identical to the relevance from the source image 222 to the target image 224, which is represented as A:A′::B:B′. In this process, only the target image B′ 224 is needed to be determined.

However, the inventors have discovered through research that: the above solution is not applicable in many scenarios because it is usually difficult to obtain different visual style versions of the same image to estimate the style mapping. For example, if it is expected to obtain appearances of a scene of a source image in different seasons, it may be difficult to find a plurality of reference images that each have the appearances of the same scene in different seasons to determine a corresponding style mapping for transferring the source image. The inventors have found that in most scenarios there are provided only two images and it is expected to transfer the visual style of one of the images to be the visual style of the other one.

As an example, in the example of FIG. 2, it is possible that only the images 212 and 224 are provided and it may be expected to process the image 212 to present the second visual style of the image 224, and/or to process the image 224 to present the first visual style of the image 212. Furthermore, most visual style transfer solutions can be directly performed in the image pixel space, which is thus difficult to take different aspects of the visual style into consideration effectively during the style transfer.

Implementations of the subject matter described herein provide a new solution for image stylization transfer. In this solution, two source images are given and it is expected to transfer one of the two source images to have at least partially the visual style of the other image. Specifically, respective feature maps of the two source images are extracted, and a mapping from one of the source images to the other one is determined based on the respective feature maps. With the determined mapping, the source image will then be transferred to a target image that at least partially has the visual style of the other source image. Through the implementations of the subject matter described herein, in the case that only two source images having respective visual styles are given, a mapping from one of the source images to the other source image is determined in the feature space based on their respective feature maps, thereby achieving an effective transfer of visual styles.

Various implementations of the subject matter described herein will be further described by way of explicit examples below.

### System Architecture and Operating Principles

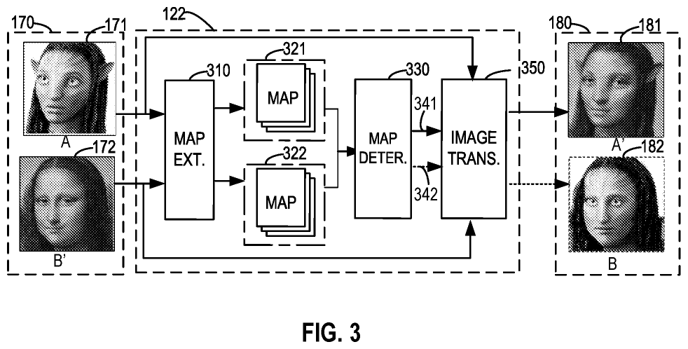

Reference is made to FIG. 3, which shows a block diagram of a system for visual style transfer of images in accordance with an implementation of the subject matter described herein. The system can be implemented at the image processing module 122 of the computing device 100. As illustrated, the image processing module 122 includes a feature map extraction part 310, a mapping determination part 330, and an image transfer part 350. In the example of FIG. 2, input images 170 obtained by the image processing module 122 includes two source images 171 and 172, each respectively referred to as a first source image 171 and a second source image 172.

The first source image 171 and the second source image 172 can have any identical or different sizes and/or formats. In some implementations, the first source image 171 and the second source image 172 are images similar in semantics. As used herein, a “semantic” image or a “semantic structure” of an image refers to image contents of an identifiable object(s) in the image. Images similar in semantic or semantic structure can include similar identifiable objects, such as objects similar in structure or profile. For instance, both the first source image 171 and the second source image 172 can include close-up faces, some actions, natural sceneries, objects with similar profiles (such as architectures, tables, chairs, appliance), and the like. In other implementations, the first source image 171 and the second source image 172 can be any images intended for style transfer.

According to implementations of the subject matter described herein, it is expected to perform visual style transfer on at least one of the two input source images 171 and 172 such that the visual style of one of the source images 171 and 172 can be transferred to the visual style of the other source image. The visual style of the first source image 171 (also referred to as the first visual style) can be different from the visual style of the second source image 172 (also referred to as the second visual style) for the purpose of style transfer. Of course, this is not necessary. Two images having any visual styles can be processed by the image processing module 122. In the following, the basic principles of the visual style transfer is first introduced according to implementations of the subject matter described herein and then the visual style transfer is introduced through the image processing module 122 of FIG. 3.

In the implementations of the subject matter described herein, the question of visual style transfer is represented as: with the first source image 171 (denoted by A) and the second source image 172 (denoted by B′) given, how to determine a first target image (denoted by A′, which is the image 181 of output images 180 in FIG. 3) for the first source image 171 that having at least partially the second visual style, or how to determine a second target image (denoted by B, which is the image 182 of the output images 180 in FIG. 3) for the second source image 172 that at least partially having the first virtual style. In determining the first target image A′ 181, it is desired that the first target image A′ 181 and the first source image A 171 are maintained to be similar in image contents and thus their pixels are corresponding at the same positions of the images. In addition, it is desired that the first target image A′ 181 and the second source image B′ 172 are also similar in visual style (for example, in color, texture, brightness, lines, and so on). If the second source image B′ 172 is to be transferred, the determination of the second target image B 182 may also meet similar principles; that is, the second target image B 182 is maintained to be similar to the second source image B′ 172 in image contents and is similar to the first source image A 171 in visual style at the same time.

To perform visual style transfer for the source image 171 or 172, a mapping between the two source images is needed to be determined. The mapping between images refers to correspondence between some pixel positions in one image and some pixel positions in the other image and is thus called as image correspondence. The determination of the mapping facilitates to transfer the images on the basis of the mapping so as to replace pixels of one image with corresponding pixels of the other image. In this way, the transferred image can present the visual style of the further image while maintaining similar image contents.

In the example of FIG. 3, if the first visual style of the first source image A 171 is to be transferred to have the first target image A′ 181 with at least partially the second visual style of the second source image B′ 172, the to-be-determined mapping from the first source image A 171 to the second source image B′ 172 is referred to as a first mapping (denoted by Φ_{a→b}). The first mapping Φ_{a→b} can represent a mapping from pixels of the first source image 171 to corresponding pixels of the second source image B′ 172. Similarly, if the second visual style of the second source image B′ 172 is to be transferred to have the second target image B 182 with at least partially the first visual style of the first source image A 171, the to-be-determined mapping from the second source image B′ 172 to the first source image A 171 is referred to as a second mapping (denoted by Φ_{b→a}).

The determination of the first mapping Φ_{a→b} is first discussed in details below in the case that the visual style of the first source image A 171 is to be transferred. The second mapping Φ_{b→a} is an inverse mapping of the first mapping Φ_{a→b} and can also be determined in a similar way if required.

According to implementations of the subject matter described herein, the mapping between the source images is determined in the feature space. Specifically, in the example of FIG. 3, the feature map extraction part 310 extracts a first set of feature maps 321 of the first source image A 171 and a second set of feature maps 322 of the second source image B′ 172. A feature map in the first set of feature maps 321 represents at least a part of the first visual style of the first source image A 171 in a respective dimension, and a feature map in the second set of feature maps 322 represents at least a part of the second visual style of the second source image B′ 172 in a respective dimension. The first visual style of the first source image A 171 or the second visual style of the second source image B′ 172 can be represented by a plurality of dimensions, which may include, but are not limited to, visual attributes of the image such as color, texture, brightness, lines, and the like. Extracting feature maps from the source images 171 and 172 can effectively represent a semantic structure (for reflecting the image content) of the image and separate the image content and the visual style of the respective dimensions of the source image. The extraction of the feature maps of the image will be described in details below.

The first and second sets of feature maps 321 and 322 extracted by the feature map extraction part 310 are provided to the mapping determination part 330, which determines, based on the first and second sets of feature maps 321 and 322, in the feature space a first mapping Φ_{a→b} from the first source image A 171 to the second source image B′ 172 as an output 341. The first mapping Φ_{a→b} determined by the mapping determination part 330 may indicate a mapping from a pixel at a position of the first source image A 171 to a pixel at a position of the second source image B′ 172. That is, for any pixel at a position p in the first source image A 171, a mapped position q to which the position p is mapped in the second source image B′ 172 can be determined through the first mapping 341 Φ_{a→b}. The mapping determination in the feature space will be discussed in details in the following.

The first mapping 341 is provided to the image transfer part 350, which transfers the first source image A 171 based on the first mapping 341 Φ_{a→b} and the second source image B′ 172, to generate the first target image A′ 181, as shown in FIG. 3. With the first mapping 341 Φ_{a→b}, the image transfer part 350 can determine a pixel position q of the second source image B′ 172 to which each position p of the first source image A 171 is mapped. Thus, the pixel at the position p of the first source image A 171 is replaced with the pixel at the mapped position q of the second source image B′ 172. The image with the replaced pixels after the mapping is considered as the first target image A′ 181. Therefore, the first target image A′ 181 has partially or completely the second visual style of the second source image B′ 172. The mapping process can be represented as:

A′(p)=B′(Φ_{a→b}(p)) (1-1)

where A′(p) represents a pixel at a position p of the first target image A′ 181, Φ_{a→b}(p) represents a position q of the second source image B′ 172 to which the position p in the target image A′ 181 is mapped by the first mapping Φ_{a→b}, and B′(Φ_{a→b}(p)) represents the pixel at the position Φ_{a→b}(p) of the second source image B′ 172.

In some other implementations, instead of replacing pixels of the first source image A 171, the first source image A 171 is transferred by block aggregation. Specifically, for a position p of the first source image A 171, a block N(p) including the pixel at the position p is identified in the first source image A 171. The size of N(p) can be configured, for example, according to the size of the first source image A 171. The size of the block N(p) will be larger if the size of the first source image A 171 is larger. A block of the second source image B′ 172, to which the block N(p) of the first source image A 171 is mapped, is determined by the first mapping. The mapping between the blocks can be determined by the pixel mapping in the blocks. Then, a pixel at the position p of the first source image A 171 can be replaced with an average value of the pixels of the mapped block in the second source image B′ 172, which can be represented as:

$${A}^{′} ( p ) = \frac{1}{n} {\sum }_{x ∈ N ( p )} ( {B}^{′} ( {Φ}_{a \to b} ( x ) ) \qquad ( 1 \text{-} 2 )$$

where n represents the number of pixels in the block N(p), Φ_{a→b} [symbol] represents a position in the second source image B′ 172 to which the position x in the block N(p) is mapped by the first mapping 341, and B′(Φ_{a→b} [symbol] represents the pixel at the mapped position Φ_{a→b} [symbol] in the second source image B′ 172.

As an alternative, or in addition to directly transferring the first source image A 171 according to the above Equations (1-1) and (1-2), the first mapping Φ_{a→b}, the target image transferred directly by the first mapping Φ_{a→b} and/or the first source image A 171 may be further processed, such that the obtained first target image A′ 181 can has only a part of the visual style of the second source image B′ 172. For example, the first target image A′ 181 can only represent the visual style of the second source image B′ 172 in some dimension, such as the color, texture, brightness and line, and can reserve the visual style of other dimensions of the first source image A 171. The variations in this regard can be implemented by different manners and the implementations of the subject matter described herein are not limited in this aspect.

In the implementations of the subject matter described herein, the pixel-level mapping between the source images is obtained in the feature space. The mapping can not only allow the transferred first target image 181 to maintain the semantic structure (i.e., image content) of the first source image 171, but also apply the second visual style of the second source image 172 to the first target image 181. Accordingly, the first target image 181 is similar to the first source image 171 in image content and the second source image 172 in visual style as well.

In optional implementations described below, if the visual style of the second source image B′ 172 is expected to be transferred, the mapping determination part 330 can also determine, based on the first and second sets of feature maps 321 and 322, in the feature space the second mapping Φ_{b→a} from the second source image B′ 172 to the first source image A 171 as the output 342. The image transfer part 350 transfers the second source image B′ 172 based on the second mapping Φ_{b→a} and the first source image A 171, to generate the second target image B 182 as shown in FIG. 3. Therefore, the second target image B 182 has partially or completely the first visual style of the first source image A 171. The second target image B 182 is generated in a similar way to the first target image A′ 181, which is omitted here for brevity.

### Extraction of Feature Maps

In extracting feature maps, the feature map extraction part 310 may use a predefined learning network. The source images 171 and 172 can be input into the learning network, from which the output feature maps are obtained. Such learning network is also known as a neural network, learning model, or even a network or model for short. For the sake of discussion, these terms can be used interchangeably herein. A predefined learning network means that the learning network has been trained with training data and thus is capable of extracting feature maps from new input images. In some implementations, the learning network, which is trained for the purpose of identifying objects, can be used to extract the plurality of feature maps of the source images 171 and 172. In other implementations, learning networks that are trained for other purposes can also be used as long as they can extract feature maps of the input images during runtime.

The learning network may have a hierarchical structure and include a plurality of layers, each of which can extract a respective feature map of a source image. Therefore, in FIG. 3, the first set of feature maps 321 are extracted from the plurality of layers of the hierarchical learning network, respectively, and the second set of feature maps 322 are also extracted from the plurality of layers of the hierarchical learning network, respectively. In the hierarchical learning network, the feature maps of a source image are processed and generated in a “bottom-up” manner. A feature map extracted from a lower layer can be transmitted to a higher layer for subsequent processing to acquire a corresponding feature map. Accordingly, the layer that extracts the first feature map can be a bottom layer of the hierarchical learning network while the layer that extracts the last feature map can be a top layer of the hierarchical learning network. By observing and analyzing feature maps of a large amount of the hierarchical learning networks, it is seen that the feature maps extracted by lower layers can represent richer detailed information of the source image, including the image content and the visual style of more dimensions. When the higher layers continuously process the feature maps of the lower layers, the visual style of different dimensions in the previous feature maps may be separated and represented by the feature map(s) extracted by one or more layers. The feature maps extracted at the top layer can be taken to represent mainly the image content information of the source image and merely a small portion of the visual style in the source image.

The learning network can be consisted of a large number of learning units (also known as neurons). The corresponding parameters of the neurons are determined through the training process so as to achieve the extraction of feature maps and subsequent tasks. Various types of learning networks can be employed. In some examples, the feature map extraction part 310 can be implemented by a convolutional neural network (CNN), which is good at image processing. The CNN network mainly consists of a plurality of convolution layers, excitation layers (composed of non-linear excitation functions, such as ReLU functions) performing non-linear transfer, and pooling layers. The convolution layers and the excitation layers are arranged in an alternative manner for extraction of the feature maps. In the construction of some learning networks, the pooling layers are designed to down-sample previous feature maps (e.g., down-sampling at a twice or higher rate), and the down-sampled feature maps are then provided as inputs of following layers. The pooling layers are mainly applied to construct feature maps in a shape of pyramids, in which the sizes of the outputted feature maps are getting smaller from the bottom layer to the top layer of the learning network. The feature map outputted by the bottom layer has the same size as the source image (171 or 172). The pooling layers can be arranged subsequent to the excitation layers or convolution layers. In the construction of some other learning networks, the convolution layers can also be designed to down-sample the feature maps provided by the prior layer to change the size of the feature maps.

In some implementations, the CNN-based learning network used by the feature map extraction part 310 may not down-sample the feature maps between the layers. Thus, the first set of output feature maps 321 has the same size as the first source image 171, and the second set of output feature maps 322 has the same size as the second source image 172. In this case, during the feature map extraction, the outputs of excitation layers or convolution layers in the CNN-based learning network can be considered as feature maps of the corresponding layers. Of course, the number of the excitation layers or convolution layers in the CNN-based learning network can be greater than the number of feature maps extracted for each source image.

In some other implementations, the CNN-based learning network used by the feature map extracting part 310 may include one or more pooling layers to extract the feature maps 321 or 322 with different sizes for the source images 171 or 172. In these implementations, the outputs of any of the pooling layers, convolution layers, or excitation layers may be output as the extracted feature maps. The size of a feature map may be reduced each time it passes through a pooling layer compared to when it is extracted before the pooling layer. In some implementations in which the pooling layers are included, the first set of feature maps 321 extracted from the layers of the learning network have different sizes to form a pyramid structure, and the second set of feature maps 322 can also form a pyramid architecture. These feature maps of different sizes can enable a coarse-to-fine mapping between the source images to be determined, which will be discussed below.

In some implementations, the number of the feature maps extracted for the first source image 171 or the second source image 172 can be any random value greater than 1, which can be equal to the number of layers (denoted by L) for feature map extraction in the learning network. Each of the feature maps extracted by the CNN-based learning network can be indicated as a three-dimensional (3D) tensor having components in three dimensions of width, height, and channel.

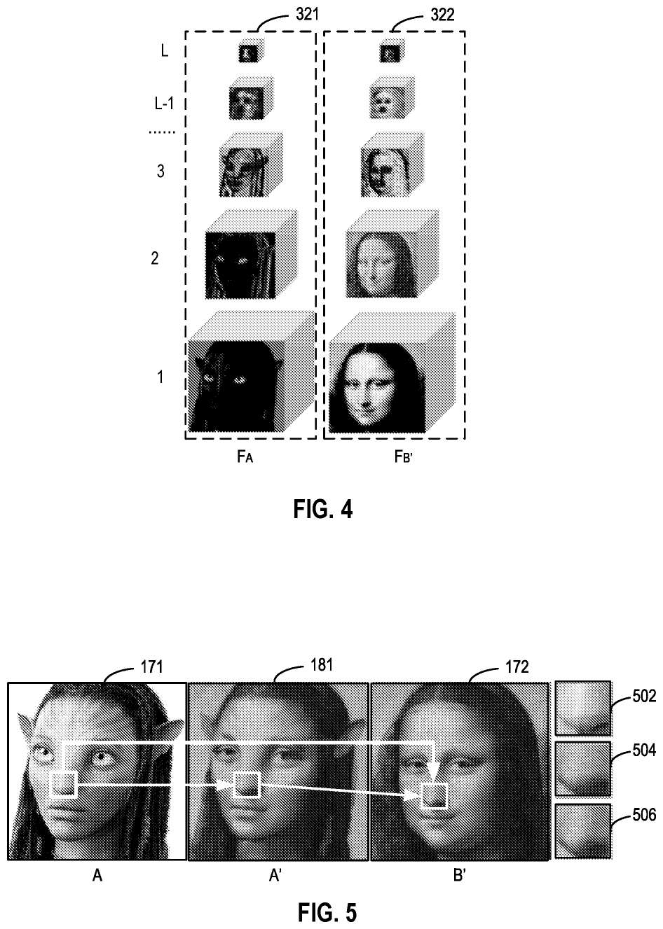

FIG. 4 shows examples of the first set of feature maps 321 (denoted by F_{A}) and the second set of feature maps 322 (denoted by F_{B′}) extracted by the learning network. In the example of FIG. 4, each of the feature maps 321 and 322 extracted from the learning network is represented by a 3D tensor having three components. The first and second sets of feature maps 321 and 322 each form a pyramid structure, in which a feature map at each layer corresponds to a respective feature extraction layer of the learning network. In the example of FIG. 3, the number of layers is L. In the first set of feature maps 321, the size of the feature map extracted from the first layer of the learning network is the maximum and is similar to the size of the source image 171, while the size of the feature map at the L-th layer is the minimum. The corresponding sizes of the second set of feature maps 322 are similar.

It would be appreciated that some examples of learning networks for feature map extraction are provided above. In other implementations, any other learning networks or CNN-based networks with different structures can be employed to extract feature maps for the source images 171 and 172. Furthermore, in some implementations, the feature map extraction part 310 can also use different learning networks to extract the feature maps for the source images 171 and 172, respectively, as long as the number of the extracted feature maps is the same.

### Determination of Mapping between Images

A mapping is determined by the mapping determination part 330 of FIG. 3 based on the feature maps 321 and 322 of the first and second source images A 171 and B′ 172. The determination of the first mapping 341 Φ_{a→b} from the first source image A 171 to the second source image B′ 172 is first described. In determining the first mapping 341 Φ_{a→b}, the mapping determination part 330 may find, based on the feature maps 321 and 322, the correspondence between positions of pixels of the first source image A 171 and positions of pixels of the second source image B′ 172. Some example implementations of determining the mapping from the feature maps will be discussed in the subject matter described herein.

According to the above discussion, to perform visual style transfer, the first mapping 341 Φ_{a→b} is determined such that the first target image A′ 181 is similar to the first source image A 171 in image content and to the second source image B′ 172 in visual style. The similarity in content enables a one-to-one correspondence between the pixel positions of the first target image A′ 181 and those of the first source image A 171. In this way, the image content in the source image A 171, including various objects, can maintain the structural (or semantic) similarity after the transfer, so that a facial contour in the source image A 171 may not be warped into a non-facial contour in the target image A′ 181 for instance. In addition, some pixels of the first target image A′ 181 may be replaced with the mapped pixel values of the second source image B′ 172 to represent the visual style of the second source image B′ 172.

Based on such mapping principle, giving the first source image A 171 and the second source image B′ 172, the process of determining the first mapping 341 Φ_{a→b} equates to a process of identifying nearest-neighbor fields (NNFs) between the first source image A 171 and the first target image A′ 181 and NNFs between the first target image A′ 181 and the second source image B′ 172. Therefore, the mapping from the first source image A 171 to the second source image B′ 182 can be divided into an in-place mapping from the first source image A 171 to the first target image A′ 181 (because of the one-to-one correspondence between the pixel positions of the two images) and a mapping from the first target image A′ 181 to the second source image B′ 172. This can be illustrated in FIG. 5.

As shown in FIG. 5, there are mappings among certain blocks of the three images A 171, A′ 181, and B′ 172. The mapping from a block 502 of the first source image A 171 to a block 506 of the second source image B′ 172 can be divided into a mapping from the block 502 to a block 504 of the first target image A′ 181 and a mapping from the block 504 to the block 506. Since the mapping from the first source image A 171 to the first target image A′ 181 is a one-to-one in-place mapping, the mapping from the first target image A′ 181 to the second source image B′ 172 is equivalent to the mapping from the first source image A 171 to the second source image B′ 172, both of which can be represented by Φ_{a→b}. This relationship can be applied into the determination of the first mapping Φ_{a→b} by the mapping module 330 so as simplify the process of directly determining the mapping from the first source image A 171 to the second source image B′ 172.

In the mapping from the first target image A′ 181 to the second source image B′ 172, it is expected that the first target image A′ 181 is similar to the second source image B′ 172 in visual style. Since the feature maps in the feature space represent different dimensions of the visual style of the images, the determined first mapping Φ_{a→b} may also be capable of enabling the first target image A′ 181 to have a similarity with the second source image B′ 172, that is, achieving the NNFs between the first target image A′ 181 and the second source image B′ 172. As the feature maps of the first target image A′ 181 are unknown, as can be seen from the following discussion, the determination of the first mapping Φ_{a→b} may involve reconstruction of the feature maps of the first target image A′ 181.

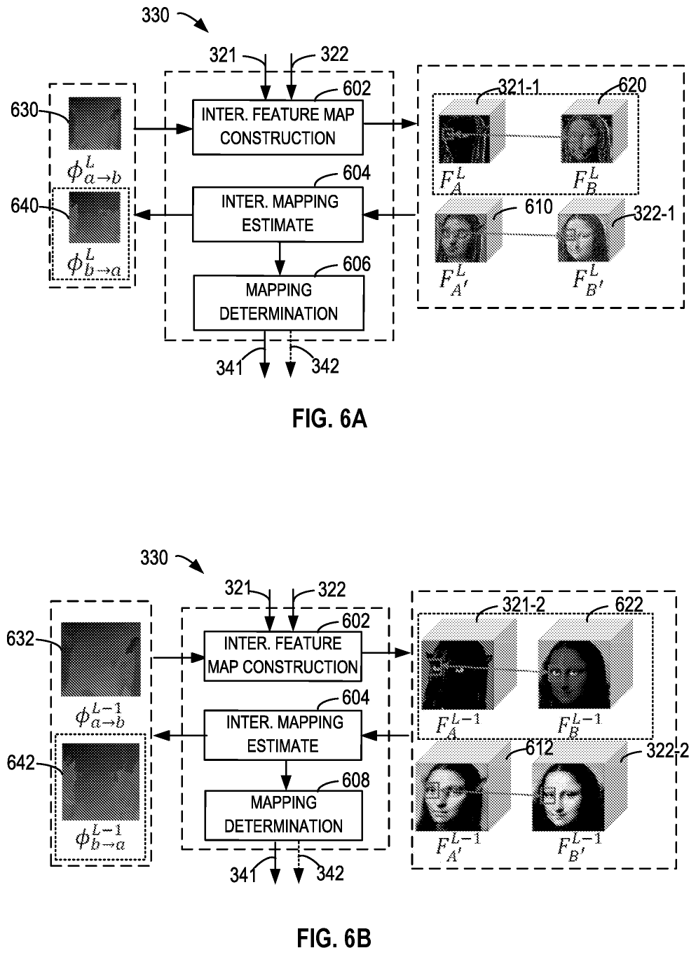

In some implementations, because both feature maps 321 and 322 are obtained from a hierarchical learning network, especially from the CNN-based learning network, the features maps extracted therefrom may thus provide a gradual transition from the rich visual style content at the lower layers to the image content with a low level of visual style content at the higher layers. The mapping determination part 330 can determine the first mapping Φ_{a→b} in an iterative way according to the hierarchical structure. FIGS. 6A and 6B show a block diagram of an example structure of the mapping determination part 330. As illustrated, the mapping determination part 330 includes an intermediate feature map reconstruction module 602, an intermediate mapping estimate module 604, and a mapping determination module 606. The intermediate feature map reconstruction module 602 and the intermediate mapping estimate module 604 iteratively operate on the first set of feature maps 321 and the second set of feature maps 322 extracted from the respective layers of the hierarchical learning network.

The intermediate feature map reconstruction module 602 reconstructs the feature maps for the unknown first target image A′ (referred to as intermediate feature maps) based on the known feature maps (i.e., the first set of feature maps 321 and/or the second set of feature maps 322). In some implementations, supposing that the number of layers in the hierarchical learning network is L, the number of feature maps in the first or second set of feature maps 321 or 322 is also L. The intermediate feature map reconstruction module 602 can determine the feature maps for the first target image A′ iteratively from the top to the bottom of the hierarchical structure.

### Intermediate Feature Maps and Intermediate Mappings

For the top layer L, because the feature map 321-1 (denoted by F_{A}^{L}) in the first set of feature maps 321 (denoted by F_{A}) extracted from the top layer includes more image content and less visual style information, the intermediate feature map reconstruction module 602 can estimate the feature map 610 (denoted by F_{A′}^{L}) for the first target image A′ 181 at the top layer to be equivalent to the top-layer feature map of the feature map 321-1, that is, F_{A′}^{L}=F_{A}^{L}. The estimated feature map of the first target image A′ 181 at each layer, including the feature map 610, can also be referred to as an intermediate feature map associated with the first source image A 171. It is supposed that the feature map 322-1 in the second set of feature maps 322 of the second source image B′ 172 extracted from the top layer is denoted by F_{B′}^{L}.

The top-layer feature map 610 F_{A′}^{L} for the first target image A′ 181 and the top-layer feature map F_{B′}^{L} of the second source image B′ 172 also meet a mapping relationship. It is supposed that this mapping relationship represents an intermediate mapping for the top layer, which may be represented as ϕ_{a→b}^{L}. The intermediate feature map reconstruction module 602 provides the determined intermediate feature map 610 F_{A′}^{L} and the feature map 322-1 F_{B′}^{L} obtained from the feature map mapping module 330 to the intermediate mapping estimate module 640 to estimate the intermediate mapping 630 ϕ_{a→b}^{L}. In the intermediate mapping estimate module 604, the target of determining the intermediate mapping ϕ_{a→b}^{L} is to enable the feature maps 610 F_{A′}^{L} and 322-1 F_{B′}^{L} to have similar pixels at corresponding positions, so as to ensure that the first target image A′ 181 is similar to the second source image B′ 172 in visual style.

Specifically, the similarity can be achieved by reducing the difference between the pixel at each position p in the intermediate feature map 610 F_{A′}^{L} and the pixel at the position q in the feature map 322-1 F_{B′}^{L} to which the position p is mapped. However, the position q in the feature map 322-1 F_{B′}^{L}, to which the position p is mapped, is determined by the intermediate mapping 630 ϕ_{a→b}^{L}. The intermediate mapping estimate module 604 can continually reducing the difference between the pixel at the position p in the intermediate feature map 610 F_{A′}^{L} and the pixel at the position q in the feature map 322-1 F_{B′}^{L} to which the position p is mapped, by continually adjusting the intermediate mapping 630 ϕ_{a→b}^{L}. When the difference meets a predetermined condition, for example, when the difference is lower than a predetermined threshold, the intermediate mapping module 604 may determine the output intermediate mapping 630 ϕ_{a→b}^{L}.

In some implementations, upon determining the intermediate mapping 630 ϕ_{a→b}^{L}, in instead of only minimizing the difference between individual pixels, the difference between the block including the pixel at the position p in the intermediate feature map 610 F_{A′}^{L} and the block including the pixel at the position q in the feature map 322-1 F_{B′}^{L} may also be reduced to a small or minimum level. That is to say, the target of the determined intermediate mapping 630 ϕ_{a→b}^{L} is to identify the nearest-neighbor fields in the intermediate feature map 610 F_{A′}^{L} and the feature map 322-1 F_{B′}^{L}. This process may be represented as follows:

$${φ}_{a \to b}^{L} ( p ) = {arg min}_{q} {\sum }_{x ∈ N ( p ) , y ∈ N ( q )} {‖ {\overline{F}}_{{A}^{′}}^{L} ( x ) - {\overline{F}}_{{B}^{′}}^{L} ( y ) ‖}^{2} \qquad ( 2 )$$

where N(p) represents a block including a pixel at a position p in the intermediate feature map 610 F_{A′}^{L} and N(q) represents a block including a pixel at a position q in the feature map 322-1 F_{B′}^{L}. The size of the respective blocks may be defined and may be dependent on the size of the feature maps F_{A′}^{L} and F_{B′}^{L}. Moreover, in Equation (2), F̅^{L}(x) represents the feature map after normalizing the vectors of all channels of the feature map F^{L}(x) at a position x in the block F^{L}(x), which may be calculated as

$${\overline{F}}^{L} ( x ) = \frac{{F}^{L} ( x )}{\vert {F}^{L} ( x ) \vert} .$$

Of course, it is also possible to omit the above normalization and use the feature F^{L}(x) directly for the determination.

According to Equation (2), the intermediate mapping 630 ϕ_{a→b}^{L} may be determined so that the pixel position q can be obtained in the feature map 322-1 F_{B′}^{L} and the difference between the block including the position q and the block N(p) in the intermediate feature map 610 F_{A′}^{L} is reduced. In the process of determining the intermediate mapping ϕ_{a→b}^{L}, the intermediate feature map ϕ_{a→b}^{L} determined by the intermediate mapping estimate module 602 is actually used as an initial estimate. The process of determining the intermediate mapping ϕ_{a→b}^{L} may change the actual intermediate feature map F_{A′}^{L}. For the other layers discussed below, other intermediate feature maps may also be changed in a similar manner.

The intermediate mapping 630 ϕ_{a→b}^{L} for the top layer L may be fed back to the intermediate feature map extraction module 602 by the intermediate mapping estimate module 604 to continue determining the intermediate feature maps at the lower layers for the first target image A′ 181. FIG. 6B illustrates a schematic diagram in which the mapping determination part 330 determines an intermediate feature map and an intermediate mapping for the layer L-1 lower than the top layer L during the iteration process. At the layer L-1, the principle for determining the intermediate mapping is similar to that at the layer L. Therefore, the intermediate mapping estimate module 604 in the mapping determination part 330 may likewise determine the intermediate mapping based on the principle similar to the one shown in the above Equation (2), such that the intermediate feature map (denoted by F_{A′}^{L-1}) at the layer L-1 for the first target image A′ 181 and the feature map 322-2 (denoted by F_{B′}^{L-1}) at the layer L-1 for the second set of feature maps 322 have similar pixels at corresponding positions.

Since the feature maps of the lower layers in the hierarchical structure may contain more information on the visual style, when constructing the intermediate feature 612 F_{A′}^{L-1} at the layer L-1 for the first target image A′ 181, the intermediate feature map construction module 602 is expected to take the feature map 321-2 (denoted by F_{A}^{L-1}) in the first set of feature maps 321 of the first source image A 171 into account, which is extracted from the layer L-1 of the learning network, so as to ensure the similarity in content. In addition, the feature map 322-2 (denoted by F_{B′}^{L-1}) in the second set of feature maps 322 of the second source image B′ 172 extracted at layer L-1 is also taken into account to ensure similarity in visual style. Since the feature map 322-2 and the feature map 321-2 do not have a one-to-one correspondence at the pixel level, the feature map 322-2 is needed to be transferred or warped to be consistent with the feature map 321-2. The obtained result may be referred to as a transferred feature map (denoted by S(F_{B′}^{L-1})), which has pixels completely corresponding to those of the feature map 321-2. As will be discussed below, the transferred feature map obtained by transferring the feature map 322-2 may be determined based on the intermediate mapping of the layer above the layer L-1 (that is, the layer L).

The intermediate feature map construction module 602 may determine the intermediate feature map 612 F_{A′}^{L-1} at the layer L-1 for the first target image A′ 181 by fusing (or combining) the transferred feature map and the feature map 321-2. In some implementations, the intermediate feature map construction module 602 can merge the transferred feature map with the feature map 321-2 according to respective weights, which can be represented as follows:

F_{A′}^{L-1}=F_{A}^{L-1}∘W_{A}^{L-1}+S(F_{B′}^{L-1})∘(1−W_{A}^{L-1}) (3)

where ∘ represents element-wise multiplication on each channel of a feature map, W_{A}^{L-1} represents a weight for the feature map 321-2 F_{A}^{L-1}, and (1−W_{A}^{L-1}) represents a weight for the transferred feature map S(F_{B′}^{L-1}). W_{A}^{L-1} may be a 2D weight map with each element valued from 0 to 1. In some implementations, each channel of the 3D feature maps F_{A}^{L-1} and S(F_{B′}^{L-1}) uses the same weight maps W_{A}^{L-1} and F_{A′}^{L-1} to balance the ratio of details of the image structural content and of the visual style in the intermediate feature map 612 F_{A′}^{L-1}. By multiplying the feature map 321-2 F_{A}^{L-1} by the weight W_{A}^{L-1} and multiplying the transferred feature map S(F_{B′}^{L-1}) by the weight (1−W_{A}^{L-1}), the image content information in the feature map 321-2 F_{A}^{L-1} and the visual style information in the transferred feature map S(F_{B′}^{L-1}) are combined into the intermediate feature map 612 F_{A′}^{L-1}. The determination of the weight w_{A}^{L-1} will be discussed in details below.

When the intermediate feature map construction module 602 generates the intermediate feature map 612 F_{A′}^{L-1}, the intermediate feature map 612 F_{A′}^{L-1} is provided to the intermediate mapping estimate module 604 as well as the feature map 322-2 F_{B′}^{L-1} in the second set of feature maps 322 that is extracted at layer L-1. The intermediate mapping estimate module 604 determines the intermediate mapping 632 ϕ_{a→b}^{L-1} for the layer L-1 based on the above information. The way for estimating the intermediate mapping 632 may be similar to that described above for determining the intermediate mapping 630 for the layer L. For example, the determination of the intermediate mapping 632 aims to reduce the difference between a pixel at a position p in the intermediate feature map 612 F_{A′}^{L-1} and a pixel at a position q in the feature map 322-2 F_{B′}^{L-1} to which the position p is mapped with the intermediate mapping 632 so as to satisfy a predetermined condition (for example, being lower than a predetermined threshold). This can be determined in a way similar to the above Equation (2), which is omitted here for sake of brevity.

It has been discussed above the estimation of the intermediate feature maps for the first target image A′ 181 at corresponding layers L and L-1 and the determination of the intermediate mapping for the layers based on the intermediate feature maps In some implementations, the intermediate feature map reconstruction module 602 and the intermediate mapping estimate module 604 may continue to iteratively determine respective intermediate feature maps and respective intermediate mappings for the layers below the layer L-1. In some implementations, the calculation in the intermediate feature map reconstruction module 602 and the intermediate mapping estimate module 604 can be iterated until the intermediate mapping ϕ_{a→b}¹ for the bottom layer (layer 1) of the learning network is determined. In some implementations, only intermediate mappings for some higher layers may be determined.

### Determination of the First Mapping

The intermediate mappings determined by the intermediate mapping estimate module 604 for the respective layers below the top layer L of the learning network can be provided to the mapping determination module 608 to determine the first mapping 341 Φ_{a→b}. In some implementations, if the intermediate mapping estimate module 604 estimates the intermediate mapping ϕ_{a→b}¹ for the layer 1, this intermediate mapping can be provided to the mapping determination module 608. The mapping determination module 608 can directly determine the intermediate mapping ϕ_{a→b}¹ for the layer 1 as the first mapping 341 Φ_{a→b}.

In other implementations, the intermediate mapping estimate module 604 may not calculate the intermediate mappings for all layers of the learning network, and thus the intermediate mapping determined for some layers above the layer 1 can be provided to the mapping determination module 608 for determining the first mapping 341. If the first set of feature maps 321 have the same size (which is equal to the size of the first source image A 171), the intermediate mappings provided by the intermediate mapping estimate module 604 have also the same size of the first mapping 341 (which is also equal to the size of the first source image A 171) and can thus be directly used to determine the first mapping 341. If the feature maps extracted from higher layers of the learning network has a size smaller than that of the first source image A 171, the mapping determination module 608 can further process the intermediate mapping obtained for the layer above the layer 1, for example, by up-sampling the obtained intermediate mapping to the same size as required for the first mapping 341.

### Determination of Transferred Feature maps

It will be discussed below how to determine a transferred feature map for each layer at the intermediate feature map reconstruction module 602 during the above iteration process. In the following, the transferred feature map S(F_{B′}^{L-1}) for the layer L-1 is taken as an example for discussion. When it is iterated to other layers, the intermediate feature map reconstruction module 602 can also determine a respective transferred feature map in a similar manner to reconstruct the intermediate feature maps.

Ideally, it is expected that the transferred feature map S(F_{B′}^{L-1}) is equal to the warped or transferred result of the feature map 322-2 in the second set of feature maps 322 at the layer L-1, that is, S(F_{B′}^{L-1})=F_{B′}^{L-1}(ϕ_{a→b}^{L-1}). However, since the intermediate mapping ϕ_{a→b}^{L-1} for layer L-1 is unknown, it is impossible to directly determine the transferred feature map S(F_{B′}^{L-1}). In some implementations, the intermediate mapping ϕ_{a→b}^{L-1} fed back by the intermediate mapping estimate module 604 for the layer L can be used to enable the intermediate feature map reconstruction module 602 to determine the transferred feature map S(F_{B′}^{L-1}).

In some implementations, the intermediate feature map reconstruction module 602 can determine an initial mapping for the intermediate mapping ϕ_{a→b}^{L-1} for the current layer L-1 based on the intermediate mapping ϕ_{a→b}^{L} for the upper layer L. In an implementation, if the feature map is down-sampled (e.g., going through the pooling layer) from the layer L-1 to the layer L in the learning network, the intermediate mapping ϕ_{a→b}^{L} for the upper layer L may be up-sampled and then the up-sampled mapping is used as the initial mapping of the intermediate mapping ϕ_{a→b}^{L-1}, so as to meet the size of the to-be-transferred feature map 322-2 F_{B′}^{L-1} at layer L-1. If the size of the feature maps from the layer L-1 to the layer L remains the same in the learning network, the intermediate mapping ϕ_{a→b}^{L} can directly serve as the initial mapping of the intermediate mapping ϕ_{a→b}^{L-1}. Then, the intermediate feature map reconstruction module 602 may transfer the feature map 322-2 F_{B′}^{L-1} using the initial mapping of the intermediate mapping ϕ_{a→b}^{L-1}, which is similar to S(F_{B′}^{L-1})=F_{B′}^{L-1}(ϕ_{a→b}^{L-1}) where the difference only lies in that ϕ_{a→b}^{L-1} is replaced with its estimated initial mapping.

The initial estimate for the intermediate mapping ϕ_{a→b}^{L-1} based on the intermediate mapping ϕ_{a→b}^{L} may fail to remain the mapping structure of the feature map from the upper layer, thereby introducing deviation into the subsequent estimate of the first mapping 341. In another implementation, the intermediate feature map reconstruction module 602 can first transfer the feature map 322-1 in the second set of feature maps 322 extracted from the layer L by use of the known intermediate mapping ϕ_{a→b}^{L}, to obtain a transferred feature map of the feature map, F_{B′}^{L}(ϕ_{a→b}^{L}). In the learning network from which the feature maps are extracted, the transferred feature map F_{B′}^{L}(ϕ_{a→b}^{L}) for the layer L and the transferred feature map S(F_{B′}^{L-1}) for the layer L-1 can also satisfy the processing principle in the learning network even though they have experienced the transfer process. That is, it is expected to obtain the transferred feature map F_{B′}^{L}(ϕ_{a→b}^{L}) for the layer L by performing a feature transformation from the lower layer L-1 to the upper layer L on the target transferred feature map S(F_{B′}^{L-1}) for the layer L-1.

It is supposed that feature transformation processing of all the neural network processing units or layers included in a sub-network of the learning network between the layer L-1 and the layer L is denoted as CNN_{L-1}^{L}(⋅). The target of determining the transferred feature map S(F_{B′}^{L-1}) for the layer L-1 is to enabling the output of CNN_{L-1}^{L}(S(F_{B′}^{L-1})) (also referred to as a further transferred feature map) to approach to the transferred feature map F_{B′}^{L}(ϕ_{a→b}^{L}) for the layer L as closed as possible. In some implementations, S(F_{B′}^{L-1}) may be obtained by an inverse process of CNN_{L-1}^{L}(⋅) with respect the transferred feature map F_{B′}^{L}(ϕ_{a→b}^{L}). However, it may be difficult to directly perform the inverse process because CNN_{L-1}^{L}(⋅) involves a large amount of non-linear processing. In other implementations, the target transferred feature map S(F_{B′}^{L-1}) for the layer L-1 can be determined by an iteration process.

In the iteration process for determining S(F_{B′}^{L-1}), S(F_{B′}^{L-1}) may be initialized with random values. Then, the difference between the transferred feature map outputted by CNN_{L-1}^{L}(S(F_{B′}^{L-1})) and the transferred feature map F_{B′}^{L}(ϕ_{a→b}^{L}) for the layer L is reduced (for example, to meet a predetermined condition such as a predetermined threshold) by continually updating S(F_{B′}^{L-1}). In an implementation, S(F_{B′}^{L-1}) is continually updated in the iteration process through gradient descent to obtain the target S(F_{B′}^{L-1}) at a higher speed. This process may be represented as decreasing or minimizing the following loss function:

[symbol]

_{S(F}_{_{B′}}_{^{L-1}}₎=∥CNN_{L-1}^{L}(S(F_{B′}^{L-1}))−F_{B′}^{L}(ϕ_{a→b}^{L})∥² (4)

In the case where gradient descent is used, the gradient ∂ [symbol] _{S(F}_{_{B′}}_{^{L-1}}₎/∂S(F_{B′}^{L-1}) can be determined. Various optimization methods can be employed to determine the gradient and update S(F_{B′}^{L-1}), so that the loss function in Equation (4) can be decreased or minimized. For instance, the target S(F_{B′}^{L-1}) is determined by a L-BFGS (Limited-memory BFGS) optimization algorithm. Of course, other methods can be adopted to minimize the above loss function or determine the transfer feature S(F_{B′}^{L-1}) that satisfies the requirement. The scope of the subject matter described herein is not limited in this regard. The determined transferred feature map S(F_{B′}^{L-1}) can be used for the reconstruction of the intermediate feature map, such as the reconstruction as shown in Equation (3).

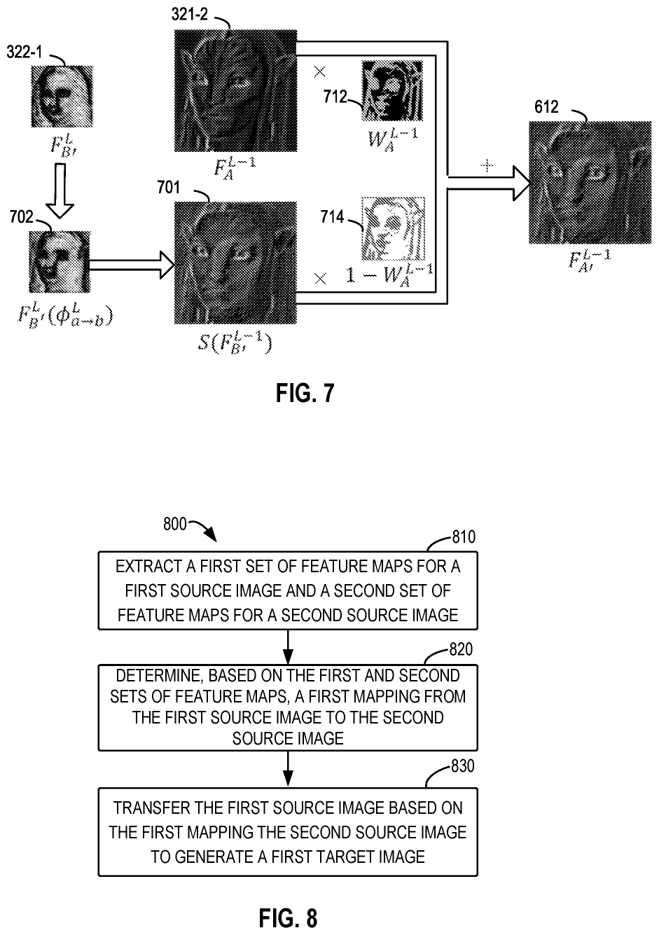

The intermediate feature map construction module 602 determines the transferred feature map for the current layer L-1 based on the transferred feature map for the upper layer L-1, and the fusing process of the feature map 321-2 and the transferred feature map S(F_{B′}^{L-1}) is shown in FIG. 7. As illustrated, the feature map 322-1 in the second set of feature maps 322 at the layer L is transferred (using the intermediate mapping ϕ_{a→b}^{L}) to obtain the transferred feature map 702 for the layer L. Based on the transferred feature map 702 for the layer L, the transferred feature map 701 S(F_{B′}^{L-1}) is further determined for the layer L-1, for example, through the above Equation (4). The transferred feature map 701 S(F_{B′}^{L-1}) and the feature map 321-2 in the second set of feature maps 321 at the layer L-1 are fused with the respective weight maps (1−W_{A}^{L-1}) 714 and W_{A}^{L-1} 712 to obtain the intermediate feature map 612.

### Weight Determination in Reconstruction of Intermediate Feature Maps

In the above iteration process, the intermediate feature map reconstruction module 602 can also fuse, based on the weight, the transferred feature map determined for each layer with the corresponding feature map in the second set of feature maps 322. In the following, the weight W_{A}^{L-1} used for the layer L-1 is taken as an example for discussion. When it is iterated to other layers, the intermediate feature map reconstruction module 602 can determine the respective weights in a similar way.

At the layer L-1, the intermediate feature map reconstruction module 602 fuses the feature map 321-2 F_{A}^{L-1} with the transferred feature map 701 S(F_{B′}^{L-1}) based on their respective weights (i.e., the weights W_{A}^{L-1} and (1−W_{A}^{L-1})) as mentioned above. The weight W_{A}^{L-1} balances in the intermediate feature map 612 F_{A′}^{L-1} the ratio of details of the image structural content of the feature map 321-2 F_{A}^{L-1} and the visual style included in the transferred feature map 701 S(F_{B′}^{L-1}). In some implementations, the weight W_{A}^{L-1} is expected to help define a space-adaptive weight for the image content of the first source image A 171 in the feature map 321-2 F_{A}^{L-1}. Therefore, the values at corresponding positions in the feature map 321-2 F_{A}^{L-1} can be taken into account. If a position x in the feature map 321-2 F_{A}^{L-1} belongs to an explicit structure in the first source image A 171, the response of that position at a corresponding feature channel will be large in the feature space, which means that the amplitude of the corresponding channel in |F_{A}^{L-1}(x)| is large. If the position x lies in a flat area or an area without any structures, |F_{A}^{L-1}(x)| is small, for example, |F_{A}^{L-1}(x)|→0.

In some implementations, the influence on the weight W_{A}^{L-1} by the value at a respective position in the feature map 321-2 F_{A}^{L-1} is represented as M_{A}^{L-1}. The influence factor M_{A}^{L-1} can be a 2D weight map corresponding to W_{A}^{L-1} and can be determined from F_{A}^{L-1}. In some implementations, the value M_{A}^{L-1} [symbol] of W_{A}^{L-1} at a position x may be determined as a function of |F_{A}^{L-1}(x)|. The relevance between M_{A}^{L-1} [symbol] and |F_{A}^{L-1}(x)| can be indicated by various function relations. For example, a sigmoid function may be applied to determine

$${M}_{A}^{L - 1} ( x ) = \frac{1}{1 + exp ( - κ \times ( \vert {F}_{A}^{L - 1} ( x ) \vert - τ ) )} ,$$

here κ and τ are predetermined constants. For example, it is possible to set κ=300 and τ=0.05. Other values of κ and τ are also possible. In some implementations, in calculating M_{A}^{L-1} [symbol] , |F_{A}^{L-1}(x)| may be normalized, for example, by the maximum value of |F_{A}^{L-1}(x)|.

In some implementations, with the influence factor M_{A}^{L-1}, the weight W_{A}^{L-1} may be determined to be equal to M_{A}^{L-1}, for example. Alternatively, or in addition, the weight w_{A}^{L-1} may also be determined based on a predetermined weight (denoted as α^{L-1}) associated with the current layer L-1. As the feature maps of the first source image A 171 extracted from different layers of the learning network are different in the aspect of representing the image contents of the source image A 171, the higher layers can represent more image contents. In some implementations, the predetermined weight α^{L-1} associated with the current layer L-1 may be used to further balance the amount of the image content in the feature map 321-2 that can be fused into the intermediate feature 612. In some implementations, the predetermined weights corresponding to the layers from the top to the bottom may be reduced progressively. For example, the predetermined weight α^{L-1} for the layer L-1 may be greater than that for the layer L-2. In some examples, the weight W_{A}^{L-1} can be determined as a function of the predetermined weight α^{L-1} for the layer L-1, for example, to be equal to α^{L-1}.

In some implementations, the weight W_{A}^{L-1} can be determined based on M_{A}^{L-1} and α^{L-1} discussed above, which can be represented as:

W_{A}^{L-1}=α_{L-1}M_{A}^{L-1} (5)

However, it would be appreciated that Equation (5) is only set forth as an example. The weight W_{A}^{L-1} can be determined by combining M_{A}^{L-1} with α^{L-1} in other manners and examples of the subject matter described herein are not limited in this regard.

### Bidirectional Constraint for Intermediate Mappings

In the implementations discussed above, the mapping from the feature maps of the first target image A′ 181 to the feature maps of the second target image B 182 is taken into account in determining the intermediate mapping, which is equivalent to the first mapping Φ_{a→b} from the first source image A 171 to the second source image B′ 172. In some other implementations, when performing the visual style transfer based on the first and second source images A 171 and B′ 172, in addition to the first mapping Φ_{a→b} from the first source image A 171 to the second source image B′ 172, there may also present a second mapping 342 Φ_{b→a}, from the second source image B′ 172 to the first source image A 171 (even if the second target image B 182 is not needed to be determined). In some implementations, the mappings in the two directions are expected to have symmetry and consistency in the process of determining the first mapping Φ_{a→b}. Such constraint can facilitate a better transfer result when the visual style transfer on the second source image B′ 172 is to be performed at the meantime.

The bidirectional mapping can be represented as Φ_{b→a}(Φ_{a→b}(p))=p. The mapping means that, with the first mapping Φ_{a→b}, the position p of the first source image A 171 (or the first target image A′ 181) is mapped to the position q=Φ_{a→b}(p) of the second source image B′ 172 (or the second target image B 182). Then, if the position q=Φ_{a→b}(p) of the second source image B′ 172 (or the second target image B 182) is continued to be mapped with the second mapping Φ_{b→a}, and the position q can still be mapped back to the position p of the first source image A 171. Based on the symmetry of the bidirectional mapping, Φ_{a→b}(Φ_{b→a}(p))=p is also solid.

In the implementations in which the first mapping Φ_{a→b} is determined under the bidirectional constraint, the constraint in the forward direction from the first source image A 171 to the second source image B′ 172 can be represented by the estimate of the intermediate feature maps conducted during the above process of determining the intermediate mappings. For example, in Equations (2) and (3), the estimate of the intermediate feature map 610 F_{A}^{L}, for the layer L and the intermediate feature map 612 F_{A}^{L-1} for the layer L-1 depends on the mappings in the forward direction, such as the intermediate mappings ϕ_{a→b}^{L} and ϕ_{a→b}^{L-1}. For other layers besides the layer L, the intermediate feature maps also depend on the intermediate mappings determined for the corresponding layers, respectively. In some implementations, the mapping determination part 330, when determining the first mapping Φ_{a→b}, can also symmetrically consider the constraint in the reverse direction from the second source image B′ 172 to the first source image A 171 in a way similar to the constraint in the forward direction. This can refer to the example implementations of the mapping determination part 330 described in FIGS. 6A and 6B.

Specifically, referring back to FIGS. 6A and 6B, the intermediate feature map reconstruction module 602 of the mapping determination part 330 can reconstruct, based on the known feature maps (i.e., the first set of feature maps 321 and/or the second set of feature maps 322), the unknown intermediate feature maps for the second target image B 182, which can be referred to as intermediate feature maps associated with the second source image B′ 172. The process of estimating the intermediate feature maps for the second target image B 182 can be similar to the above process of estimating the intermediate feature maps for the first target image A′ 181, which can be determined iteratively from the top layer to the bottom layer according to the hierarchical structure of the learning network that is used for feature extraction.

For example, as shown in FIG. 6A, for the top layer L, the intermediate feature map for the second target image B 182 can be represented as an intermediate feature map 620 F_{B}^{L}. The intermediate feature map reconstruction module 602 can determine the intermediate feature map 620 F_{B}^{L} in a manner similar to that for the intermediate feature map 610 F_{A}^{L}, which, for example, may be determined to be equal to the feature map 322-1 F_{B}^{L}, in the second set of feature maps 322 that is extracted from the top layer L. In this case, in addition to the intermediate feature map 610 F_{A′}^{L} and the feature map 322-1 F_{B′}^{L}, the intermediate feature map reconstruction module 602 also provides the determined intermediate feature map 620 F_{B}^{L} and the feature map 321-1 in the first set of feature maps 321 extracted from the layer L to the intermediate mapping estimate module 604. The intermediate mapping estimate module 604 determines the intermediate mapping 630 ϕ_{a→b}^{L} collectively based on these feature maps. In this case, the above Equation (2) is modified as:

$${φ}_{a \to b}^{L} ( p ) = {arg min}_{q} {\sum }_{x ∈ N ( p ) , y ∈ N ( q )} ( {‖ {\overline{F}}_{A}^{L} ( x ) - {\overline{F}}_{B}^{L} ( y ) ‖}^{2} + {‖ {\overline{F}}_{{A}^{′}}^{L} ( x ) - {\overline{F}}_{{B}^{′}}^{L} ( y ) ‖}^{2} ) , \qquad ( 6 )$$

where F̅^{L}(x) represents the feature map after normalizing the vectors of all channels of the feature map F^{L}(x) at a position x in the block of F^{L}(x), which can be calculated as

$${\overline{F}}^{L} ( x ) = \frac{{F}^{L} ( x )}{\vert {F}^{L} ( x ) \vert} .$$

In Equation (6), the term ∥F̅_{A}^{L}(x)−F̅_{B}^{L}(y)∥² in Equation (2) is retained and the term ∥F̅_{A}^{L}(x)−F̅_{B}^{L}(y)∥² in Equation (6) represents the constraint in the reverse direction from the second source image B′ 172 to the first source image A 171 because F̅_{B}^{L}(y is calculated from the intermediate feature map 620 F_{B}^{L} and is related to the mapping ϕ_{b→a}^{L}. It is more apparent when performing the calculation for the layers below the layer L.

For the layer L-1, the intermediate feature map reconstruction module 602 determines not only the intermediate feature map 612 F_{A′}^{L-1} associated with the first source image A 171, but also the intermediate feature map 622 F_{B}^{L-1} associated with the second source image B′ 172. The intermediate feature map 622 F_{B}^{L-1} is determined in a similar way to the intermediate feature map 612 F_{A′}^{L-1}, for example, in a similar way as presented in Equation (3). For example, the feature map 321-2 is transferred (warped) based on the intermediate mapping ϕ_{b→a}^{L} of the above layer L to obtain a corresponding transferred feature map, such that the transferred feature map has pixels in a one-to-one correspondence with pixels in the feature map 322-2. Then, the intermediate feature map reconstruction module 602 fuses the transferred feature map with the feature map 322-2, for example, based on a weight. It should also be appreciated that when fusing the feature maps, the transferred feature map and the respective weight may also be determined in a similar manner as in the implementation discussed above.

For layers below the layer L-1 in the learning network, both the intermediate feature map and the intermediate mapping can be iteratively determined in the similar way to determine the intermediate mapping for each layer for determination of the first mapping Φ_{a→b}. It can be seen from Equation (6) that the intermediate mapping ϕ_{a→b}^{L} is determined such that the difference between the block N(p) including a pixel at a position x in the feature map 321-1 and a pixel at a position y in the intermediate feature map F_{B}^{L} to which the position x is mapped is decreased or minimum. Such constraint is propagated downwards layer by layer by way of determining the intermediate mapping for the lower layers. Therefore, the first mapping Φ_{a→b} determined by the intermediate mappings can also meet the constraint in the reverse direction.

It would be appreciated although FIGS. 3 to 7 have been explained above by taking the source images 171 and 172 as examples and various images obtained from these two source images are illustrated, the illustration will not limit the scope of the subject matter described herein in any manner. In actual applications, any two random source images can be input to the image processing module 122 to achieve the style transfer therebetween. Furthermore, the images outputted from the modules, parts, or sub-modules may vary dependent on the different techniques employed in the part, modules, or sub-modules of the image processing module 122.

### Extension of Visual Style Transfer

As mentioned with reference to FIG. 3, in some implementations, a second mapping Φ_{b→a} from the second source image B′ 172 to the first source image A 171 can also be determined by the mapping determination part 330. The image transfer part 350 can transfer the second source image B′ 172 using the second mapping Φ_{b→a} to generate the second target image B 182. The second mapping Φ_{b→a} is an inverse mapping of the first mapping Φ_{a→b} and can also be determined in a similar manner to those described with reference to FIGS. 6A and 6B. For instance, as illustrated in dotted boxes of FIGS. 6A and 6B, the intermediate mapping module 604 can also determine the intermediate mapping 640 ϕ_{b→a}^{L} and the intermediate mapping 642 ϕ_{b→a}^{L-1} for different layers (such as the layers L and L-1). Of course, the intermediate mapping can be progressively determined for layers below the layer L-1 in the iteration process and the second mapping ϕ_{b→a} is thus determined from the intermediate mapping for a certain layer (such as the bottom layer 1). The specific determining process can be understood from the context and will be omitted here.

### Example Processes

FIG. 8 shows a flowchart of a process 800 for visual style transfer of images according to some implementations of the subject matter described herein. The process 800 can be implemented by the computing device 100, for example, at the image processing module 122 in the memory 120. At 810, the image processing module 122 extracts a first set of feature maps for a first source image and a second set of feature maps for a second source image. A feature map in the first set of feature maps represents at least a part of a first visual style of the first source image in a respective dimension, and a feature map in the second set of feature maps represents at least a part of a second visual style of the second source image in a respective dimension. At 820, the image processing module 122 determines, based on the first and second sets of feature maps, a first mapping from the first source image to the second source image. At 830, the image processing module 122 transfers the first source image based on the first mapping the second source image to generate a first target image, the first target image at least partially having the second visual style.

In some implementations, extracting the first set of feature maps and the second set of feature maps includes: extracting the first set of feature maps and the second set of feature maps using a hierarchical learning network with a plurality of layers, the first set of feature maps being extracted from the plurality of layers in the hierarchical learning network, respectively, and the second set of feature maps being extracted from the plurality of layers in the hierarchical learning network, respectively.

In some implementations, determining the first mapping includes: generating a first intermediate mapping for a first layer of the plurality of layers of the hierarchical learning network, the first intermediate mapping indicating a mapping from a first feature map in the first set of feature maps extracted at the first layer to a second feature map in the second set of feature maps extracted at the first layer; and determining the first mapping based on the first intermediate mapping. Generating the first intermediate mapping includes: transferring the second feature map based on the second intermediate mapping for a second layer of the plurality of layers to obtain a first transferred feature map, the second layer being above the first layer; generating a first intermediate feature map associated with the first source image by fusing the first transferred feature map with the first feature map; and determining the first intermediate mapping, such that a difference between a first pixel in the first intermediate feature map and a second pixel in the second feature map to which the first pixel is mapped using the first intermediate mapping is decreased until a first predetermined condition is met.

In some implementations, determining the first intermediate mapping further includes: transferring the first feature map based on a third intermediate mapping for the second layer to obtain a second transferred feature map; generating a second intermediate feature map associated with the second source image by fusing the second transferred feature map with the second feature map; and determining the first intermediate mapping such that the difference between a third pixel in the first feature map corresponding to the first pixel and a fourth pixel in the second intermediate feature map corresponding to the second pixel is decreased until a second predetermined condition is met.

In some implementations, transferring the second feature map to obtain the first transferred feature map includes: determining an initial mapping for the first intermediate mapping based on the second intermediate mapping; and transferring the second feature map using the initial mapping for the first intermediate mapping to obtain the first transferred feature map.

In some implementations, transferring the second feature map to obtain the first transferred feature map includes: transferring, by using the second intermediate mapping, a third feature map in the second set of feature maps extracted from the second layer to obtain a third transferred feature map; and obtaining the first transferred feature map by transferring the second feature map such that a difference between the third transferred feature map and a fourth transferred feature map is decreased until a third predetermined condition is met, the fourth transferred feature map being obtained by performing feature transformation from the first layer to the second layer on the first transferred feature map.

In some implementations, generating the first intermediate feature map includes: determining respective weights for the first transferred feature map and the first feature map based on at least one of: magnitudes at respective positions in the first feature map and a predetermined weight associated with the first layer; and fusing the first transferred feature map with the first feature map based on the determined respective weights to generate the first intermediate feature map.

In some implementations, determining the first mapping based on the first intermediate mapping includes: in response to the first layer being a bottom layer among the plurality of layers, directly determining the first intermediate mapping as the first mapping.

In some implementations, the first set of feature maps have a first plurality of different sizes and the second set of feature maps have a second plurality of different sizes.

In some implementations, the acts further include: determining a second mapping from the second source image to the first source image based on the first and second sets of feature maps; and transferring the second source image based on the second mapping and the first source image to generate a second target image, the second target image at least partially having the first visual style.

### Example Implementations

Some example implementations of the subject matter described herein are listed below.

In one aspect, the subject matter described herein provides a device, comprising: a processing unit, a memory coupled to the processing unit and comprising instructions stored thereon which, when executed by the processing unit, cause the device to perform acts including: extracting a first set of feature maps for a first source image and a second set of feature maps for a second source image, a feature map in first set of feature maps representing at least a part of a first visual style of the first source image in a respective dimension, and a feature map in the second set of feature maps representing at least a part of a second visual style of the second source image in a respective dimension; determining a first mapping from the first source image to the second source image based on the first and second sets of feature maps; and transferring the first source image based on the first mapping and the second source image to generate a first target image, the first target image at least partially having the second visual style.

In some implementations, extracting the first set of feature maps and the second set of feature maps comprises: extracting the first set of feature maps and the second set of feature maps using a hierarchical learning network with a plurality of layers, the first set of feature maps being extracted from the plurality of layers in the hierarchical learning network, respectively, and the second set of feature maps being extracted from the plurality of layers in the hierarchical learning network, respectively.

In some implementations, determining the first mapping comprises: generating a first intermediate mapping for a first layer of the plurality of layers of the hierarchical learning network, the first intermediate mapping indicating a mapping from a first feature map in the first set of feature maps extracted at the first layer to a second feature map in the second set of feature maps extracted at the first layer; and determining the first mapping based on the first intermediate mapping. Generating the first intermediate mapping includes: transferring the second feature map based on the second intermediate mapping for a second layer of the plurality of layers to obtain a first transferred feature map, the second layer being above the first layer; generating a first intermediate feature map associated with the first source image by fusing the first transferred feature map with the first feature map; and determining the first intermediate mapping, such that a difference between a first pixel in the first intermediate feature map and a second pixel in the second feature map to which the first pixel is mapped using the first intermediate mapping is decreased until a first predetermined condition is met.

In some implementations, determining the first intermediate mapping further comprises: transferring the first feature map based on a third intermediate mapping for the second layer to obtain a second transferred feature map; generating a second intermediate feature map associated with the second source image by fusing the second transferred feature map with the second feature map; and determining the first intermediate mapping such that the difference between a third pixel in the first feature map corresponding to the first pixel and a fourth pixel in the second intermediate feature map corresponding to the second pixel is decreased until a second predetermined condition is met.

In some implementations, transferring the second feature map to obtain the first transferred feature map includes: determining an initial mapping for the first intermediate mapping based on the second intermediate mapping; and transferring the second feature map using the initial mapping for the first intermediate mapping to obtain the first transferred feature map.

In some implementations, transferring the second feature map to obtain the first transferred feature map includes: transferring, by using the second intermediate mapping, a third feature map in the second set of feature maps extracted from the second layer to obtain a third transferred feature map; and obtaining the first transferred feature map by transferring the second feature map such that a difference between the third transferred feature map and a fourth transferred feature map is decreased until a third predetermined condition is met, the fourth transferred feature map being obtained by performing feature transformation from the first layer to the second layer on the first transferred feature map.

In some implementations, generating the first intermediate feature map includes: determining respective weights for the first transferred feature map and the first feature map based on at least one of: magnitudes at respective positions in the first feature map and a predetermined weight associated with the first layer; and fusing the first transferred feature map with the first feature map based on the determined respective weights to generate the first intermediate feature map.

In some implementations, determining the first mapping based on the first intermediate mapping includes: in response to the first layer being a bottom layer among the plurality of layers, directly determining the first intermediate mapping as the first mapping.

In some implementations, the first set of feature maps have a first plurality of different sizes and the second set of feature maps have a second plurality of different sizes.

In some implementations, the acts further include: determining a second mapping from the second source image to the first source image based on the first and second sets of feature maps; and transferring the second source image based on the second mapping and the first source image to generate a second target image, the second target image at least partially having the first visual style.

In another aspect, the subject matter described herein provides a method, comprising: extracting a first set of feature maps for a first source image and a second set of feature maps for a second source image, a feature map in the first set of feature maps represents at least a part of a first visual style of the first source image in a respective dimension, and a feature map in the second set of feature maps represents at least a part of a second visual style of the second source image in a respective dimension; determining, based on the first and second sets of feature maps, a first mapping from the first source image to the second source image; and transferring the first source image based on the first mapping the second source image to generate a first target image, the first target image at least partially having the second visual style.

In some implementations, extracting the first set of feature maps and the second set of feature maps comprises: extracting the first set of feature maps and the second set of feature maps using a hierarchical learning network with a plurality of layers, the first set of feature maps being extracted from the plurality of layers in the hierarchical learning network, respectively, and the second set of feature maps being extracted from the plurality of layers in the hierarchical learning network, respectively.

In some implementations, determining the first mapping comprises: generating a first intermediate mapping for a first layer of the plurality of layers of the hierarchical learning network, the first intermediate mapping indicating a mapping from a first feature map in the first set of feature maps extracted at the first layer to a second feature map in the second set of feature maps extracted at the first layer; and determining the first mapping based on the first intermediate mapping. Generating the first intermediate mapping includes: transferring the second feature map based on the second intermediate mapping for a second layer of the plurality of layers to obtain a first transferred feature map, the second layer being above the first layer; generating a first intermediate feature map associated with the first source image by fusing the first transferred feature map with the first feature map; and determining the first intermediate mapping, such that a difference between a first pixel in the first intermediate feature map and a second pixel in the second feature map to which the first pixel is mapped using the first intermediate mapping is decreased until a first predetermined condition is met.

In some implementations, determining the first intermediate mapping further comprises: transferring the first feature map based on a third intermediate mapping for the second layer to obtain a second transferred feature map; generating a second intermediate feature map associated with the second source image by fusing the second transferred feature map with the second feature map; and determining the first intermediate mapping such that the difference between a third pixel in the first feature map corresponding to the first pixel and a fourth pixel in the second intermediate feature map corresponding to the second pixel is decreased until a second predetermined condition is met.

In some implementations, transferring the second feature map to obtain the first transferred feature map includes: determining an initial mapping for the first intermediate mapping based on the second intermediate mapping; and transferring the second feature map using the initial mapping for the first intermediate mapping to obtain the first transferred feature map.

In some implementations, transferring the second feature map to obtain the first transferred feature map includes: transferring, by using the second intermediate mapping, a third feature map in the second set of feature maps extracted from the second layer to obtain a third transferred feature map; and obtaining the first transferred feature map by transferring the second feature map such that a difference between the third transferred feature map and a fourth transferred feature map is decreased until a third predetermined condition is met, the fourth transferred feature map being obtained by performing feature transformation from the first layer to the second layer on the first transferred feature map.

In some implementations, generating the first intermediate feature map includes: determining respective weights for the first transferred feature map and the first feature map based on at least one of: magnitudes at respective positions in the first feature map and a predetermined weight associated with the first layer; and fusing the first transferred feature map with the first feature map based on the determined respective weights to generate the first intermediate feature map.

In some implementations, determining the first mapping based on the first intermediate mapping comprises: in response to the first layer being a bottom layer among the plurality of layers, directly determining the first intermediate mapping as the first mapping.

In some implementations, the first set of feature maps have a first plurality of different sizes and the second set of feature maps have a second plurality of different sizes.

In some implementations, the method further comprises: determining a second mapping from the second source image to the first source image based on the first and second sets of feature maps; and transferring the second source image based on the second mapping and the first source image to generate a second target image, the second target image at least partially having the first visual style.

In a further aspect, the subject matter described herein provides a computer program product tangibly stored in a non-transient computer storage medium and including computer-executable instructions which, when executed by a device, cause the device to perform the method in the above aspect.

In a yet further aspect, the subject matter described herein provides a computer-readable medium having computer-executable instructions stored thereon which, when executed by a device, cause the device to perform the method in the above aspect.

The functionally described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Conversely, various features that are described in the context of a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A device, comprising:
a processing unit; and
a memory coupled to the processing unit and comprising instructions stored thereon which, when executed by the processing unit, cause the device to perform acts including:
extracting a first set of feature maps for a first source image and a second set of feature maps for a second source image, a feature map in the first set of feature maps representing at least a part of a first visual style of the first source image in a respective dimension, and a feature map in the second set of feature maps representing at least a part of a second visual style of the second source image in a respective dimension;
determining a first mapping from the first source image to the second source image based on the first and second sets of feature maps; and
transferring the first source image based on the first mapping and the second source image to generate a first target image, the first target image at least partially having the second visual style.

2. The device of claim 1, wherein extracting the first set of feature maps and the second set of feature maps comprises:
extracting the first set of feature maps and the second set of feature maps using a hierarchical learning network with a plurality of layers, the first set of feature maps being extracted from the plurality of layers in the hierarchical learning network, respectively, and the second set of feature maps being extracted from the plurality of layers in the hierarchical learning network, respectively.

3. The device of claim 2, wherein determining the first mapping comprises:
generating a first intermediate mapping for a first layer of the plurality of layers in the hierarchical learning network, the first intermediate mapping indicating a mapping from a first feature map in the first set of feature maps extracted at the first layer to a second feature map in the second set of feature maps extracted at the first layer, including:
transferring the second feature map based on a second intermediate mapping for a second layer of the plurality of layers to obtain a first transferred feature map, the second layer being above the first layer,
generating a first intermediate feature map associated with the first source image by fusing the first transferred feature map and the first feature map, and
determining the first intermediate mapping such that a difference between a first pixel in the first intermediate feature map and a second pixel in the second feature map to which the first pixel is mapped using the first intermediate mapping is decreased until a first predetermined condition is met; and
determining the first mapping based on the first intermediate mapping.

4. The device of claim 3, wherein determining the first intermediate mapping further comprises:
transferring the first feature map based on a third intermediate mapping for the second layer to obtain a second transferred feature map;
generating a second intermediate feature map associated with the second source image by fusing the second transferred feature map and the second feature map; and
determining the first intermediate mapping such that a difference between a third pixel in the first feature map corresponding to the first pixel and a fourth pixel in the second intermediate feature map corresponding to the second pixel is decreased until a second predetermined condition is met.

5. The device of claim 3, wherein transferring the second feature map to obtain the first transferred feature map comprises:
determining an initial mapping for the first intermediate mapping based on the second intermediate mapping; and
transferring the second feature map using the initial mapping for the first intermediate mapping to obtain the first transferred feature map.

6. The device of claim 3, wherein transferring the second feature map to obtain the first transferred feature map comprises:
transferring, by using the second intermediate mapping, a third feature map in the second set of feature maps extracted at the second layer to obtain a third transferred feature map; and
obtaining the first transferred feature map by transferring the second feature map such that a difference between the third transferred feature map and a fourth transferred feature map is decreased until a third predetermined condition is met, the fourth transferred feature map being obtained by performing feature transformation from the first layer to the second layer on the first transferred feature map.

7. The device of claim 3, wherein generating the first intermediate feature map comprises:
determining respective weights for the first transferred feature map and the first feature map based on at least one of: magnitudes at respective positions in the first feature map and a predetermined weight associated with the first layer; and
fusing the first transferred feature map and the first feature map based on the determined respective weights to generate the first intermediate feature map.

8. The device of claim 3, wherein determining the first mapping based on the first intermediate mapping comprises:
in response to the first layer being a bottom layer among the plurality of layers, directly determining the first intermediate mapping as the first mapping.

9. The device of claim 2, wherein the first set of feature maps have a first plurality of different sizes and the second set of feature maps have a second plurality of different sizes.

10. The device of claim 1, wherein the acts further include:
determining a second mapping from the second source image to the first source image based on the first and second sets of feature maps; and
transferring the second source image based on the second mapping and the first source image to generate a second target image, the second target image at least partially having the first visual style.

11. A computer-implemented method, comprising:
extracting a first set of feature maps for a first source image and a second set of feature maps for a second source image, a feature map in the first set of feature maps representing at least a part of a first visual style of the first source image in a respective dimension, and a feature map in the second set of feature maps representing at least a part of a second visual style of the second source image in a respective dimension;
determining a first mapping from the first source image to the second source image based on the first and second sets of feature maps; and
transferring the first source image based on the first mapping and the second source image to generate a first target image, the first target image at least partially having the second visual style.

12. The method of claim 11, wherein extracting the first set of feature maps and the second set of feature maps comprises:
extracting the first set of feature maps and the second set of feature maps using a hierarchical learning network with a plurality of layers, the first set of feature maps being extracted from the plurality of layers in the hierarchical learning network, respectively, and the second set of feature maps being extracted from the plurality of layers in the hierarchical learning network, respectively.

13. The method of claim 12, wherein determining the first mapping comprises:
generating a first intermediate mapping for a first layer of the plurality of layers in the hierarchical learning network, the first intermediate mapping indicating a mapping from a first feature map in the first set of feature maps extracted at the first layer to a second feature map in the second set of feature maps extracted at the first layer, including:
transferring the second feature map based on a second intermediate mapping for a second layer of the plurality of layers to obtain a first transferred feature map, the second layer being above the first layer,
generating a first intermediate feature map associated with the first source image by fusing the first transferred feature map and the first feature map, and
determining the first intermediate mapping such that a difference between a first pixel in the first intermediate feature map and a second pixel in the second feature map to which the first pixel is mapped using the first intermediate mapping is decreased until a first predetermined condition is met; and
determining the first mapping based on the first intermediate mapping.

14. The method of claim 13, wherein determining the first intermediate mapping further comprises:
transferring the first feature map based on a third intermediate mapping for the second layer to obtain a second transferred feature map;
generating a second intermediate feature map associated with the second source image by fusing the second transferred feature map and the second feature map; and
determining the first intermediate mapping such that a difference between a third pixel in the first feature map corresponding to the first pixel and a fourth pixel in the second intermediate feature map corresponding to the second pixel is decreased until a second predetermined condition is met.

15. The method of claim 13, wherein transferring the second feature map to obtain the first transferred feature map comprises:
determining an initial mapping for the first intermediate mapping based on the second intermediate mapping; and
transferring the second feature map using the initial mapping for the first intermediate mapping to obtain the first transferred feature map.
